(19) United States
(12) Patent Application Publication
(10) Pub. No.: US 2023/0378523 A1
(43) Pub. Date: Nov. 23, 2023

(54) ALL-SOLID-STATE BATTERY

(71) Applicant: SAMSUNG ELECTRO-MECHANICS CO., LTD., Suwon-si, Gyeonggi-do (KR)

(72) Inventors: Kyong-Bok Min, Suwon-si, Gyeonggi-do (KR); Ji-Hyung Jung, Suwon-si, Gyeonggi-do (KR); Jong-Min Kim, Suwon-si, Gyeonggi-do (KR); Jeong-Wook Kim, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/027,691

(22) PCT Filed: Nov. 12, 2021
(86) PCT No.: PCT/KR2021/016545

§ 371 Date: Mar. 22, 2023

(30) Foreign Application Priority Data
Dec. 31, 2020 (KR) 10-2020-0189797

(51) Int. Cl. H01M 10/0562; H01M 10/0585; H01M 10/052; H01M 50/209; H01M 50/227

(52) U.S. Cl. CPC H01M 10/0562; H01M 10/0585; H01M 10/052; H01M 50/209; H01M 50/227

(57) ABSTRACT

A all-solid-state battery includes a first battery cell in which a negative electrode current collector including a negative electrode lead portion, a first negative electrode layer, a first solid electrolyte layer and a first positive electrode layer are sequentially stacked, a second battery cell in which a second positive electrode layer, a second solid electrolyte layer and a second negative electrode layer are sequentially stacked, a third battery cell in which a third negative electrode layer, a third solid electrolyte layer, a third positive electrode layer, and a positive electrode current collector including a positive electrode lead portion are sequentially stacked, a first connection electrode connected to the first positive electrode layer and the second negative electrode layer, and a second connection electrode connected to the second positive electrode layer and the third negative electrode layer. The first to third battery cells are connected in series.

### TECHNICAL FIELD

The present disclosure relates to an all-solid-state battery.

### BACKGROUND ART

Recently, devices using electricity as an energy source have been increasing. As devices using electricity such as smartphones, camcorders, notebook PCs, and electric vehicles expand, interest in electrical storage devices using electrochemical devices is increasing. Among various electrochemical devices, lithium secondary batteries that are capable of being charged and discharged and have a high operating voltage and extremely high energy density, are in the spotlight.

A lithium secondary battery is manufactured by applying a material capable of insertion and desorption of lithium ions to a positive electrode and a negative electrode and injecting a liquid electrolyte between the positive electrode and the negative electrode, and electricity is generated or consumed by an oxidation reduction reaction according to the insertion and desorption of lithium ions in the negative electrode and the positive electrode. Such a lithium secondary battery should be basically stable in an operating voltage range of the battery, and should have performance capable of transferring ions at a sufficiently high speed.

When a liquid electrolyte such as a non-aqueous electrolyte is used in such a lithium secondary battery, there is an advantage in that the discharge capacitance and the energy density are high. However, the lithium secondary battery has problems in that it is difficult to implement a high voltage therewith, and there is a high risk of electrolyte leakage, fire, and explosion.

In order to solve the above problem, a secondary battery to which a solid electrolyte is applied instead of a liquid electrolyte has been proposed as an alternative. The solid electrolyte may be divided into a polymer-based solid electrolyte and a ceramic-based solid electrolyte, and thereamong, the ceramic-based solid electrolyte has an advantage of high stability. However, a battery using a ceramic-based solid electrolyte has a problem in that internal stress remains due to a difference in sintering shrinkage during a sintering process and mechanical strength of the battery itself is lowered due to repeated contraction and expansion in the process of repeated charging and discharging.

### DISCLOSURE OF INVENTION

### Technical Problem

An aspect of the present disclosure is to provide an all-solid-state battery having structural stability.

An aspect of the present disclosure is to provide an all-solid-state battery having improving mechanical strength.

An aspect of the present disclosure is to provide an all-solid-state battery having improved long-term reliability.

### Solution to Problem

According to an aspect of the present disclosure, an all-solid-state battery includes a first battery cell in which a negative electrode current collector including a negative electrode lead portion led out in a first direction, a first negative electrode layer, a first solid electrolyte layer and a first positive electrode layer are sequentially stacked in a third direction, different from the first direction; a second battery cell in which a second positive electrode layer, a second solid electrolyte layer and a second negative electrode layer are sequentially stacked in the third direction; a third battery cell in which a third negative electrode layer, a third solid electrolyte layer, a third positive electrode layer, and a positive electrode current collector including a positive electrode lead portion led out in a direction opposite to the negative lead portion led out in the first direction are sequentially stacked in the third direction; a first connection electrode connected to the first positive electrode layer and the second negative electrode layer; and a second connection electrode connected to the second positive electrode layer and the third negative electrode layer. The first battery cell, the second battery cell and the third battery cell are spaced apart from each other in the first direction.

### Advantageous Effects of Invention

As set forth above, according to an embodiment, an all-solid-state battery having structural stability may be provided.

An all-solid-state battery may have improving mechanical strength.

An all-solid-state battery having improved long-term reliability may be provided.

### BRIEF DESCRIPTION OF DRAWINGS

The above and other aspects, features, and advantages of the present inventive concept will be more clearly understood from the following detailed description, taken in conjunction with the accompanying drawings, in which:

FIG. 1 is a perspective view schematically illustrating an all-solid-state battery according to an embodiment of the present disclosure;

FIG. 2 is a cross-sectional view schematically illustrating a battery body of FIG. 1;

FIG. 3 is a perspective view illustrating an example of a structure of a battery cell according to an embodiment of the present disclosure;

FIG. 4 is a perspective view illustrating an example of a structure of a battery cell according to an embodiment of the present disclosure;

FIG. 5 is a cross-sectional view illustrating an example of a form of a battery cell according to an embodiment of the present disclosure; and

FIG. 6 is a perspective view schematically illustrating an all-solid-state battery according to an embodiment of the present disclosure.

### MODE FOR THE INVENTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent to one of ordinary skill in the art. The sequences of operations described herein are merely examples, and are not limited to those set forth herein, but may be changed as will be apparent to one of ordinary skill in the art, with the exception of operations necessarily occurring in a certain order. Also, descriptions of functions and constructions that would be well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will fully convey the scope of the disclosure to one of ordinary skill in the art.

Herein, it is noted that use of the term “may” with respect to an embodiment or example, e.g., as to what an embodiment or example may include or implement, means that at least one embodiment or example exists in which such a feature is included or implemented while all examples and examples are not limited thereto.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on.” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as illustrated in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other manners (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes illustrated in the drawings may occur. Thus, the examples described herein are not limited to the specific shapes illustrated in the drawings, but include changes in shape that occur during manufacturing.

The features of the examples described herein may be combined in various manners as will be apparent after gaining an understanding of the disclosure of this application. Further, although the examples described herein have a variety of configurations, other configurations are possible as will be apparent after gaining an understanding of the disclosure of this application.

The drawings may not be to scale, and the relative sizes, proportions, and depiction of elements in the drawings may be exaggerated for clarity, illustration, and convenience.

In this specification, expressions such as “A and/or B”, “at least one of A and B”, or “one or more of A and B” may include all cases of (1) including at least one A, (2) including at least one B, or (3) including both at least one A and at least one B.

In the present specification. “vertical”. “horizontal” and/or “parallel” does not mean only 90° and/or 0° in a strict sense, but may mean including an error. The error may mean, for example, ±5° or less.

In the drawings, an X direction may be defined as a first direction, an L direction or a length direction, a Y direction may be defined as a second direction, a W direction or a width direction, and a Z direction may be defined as a third direction, a T direction, or a thickness direction.

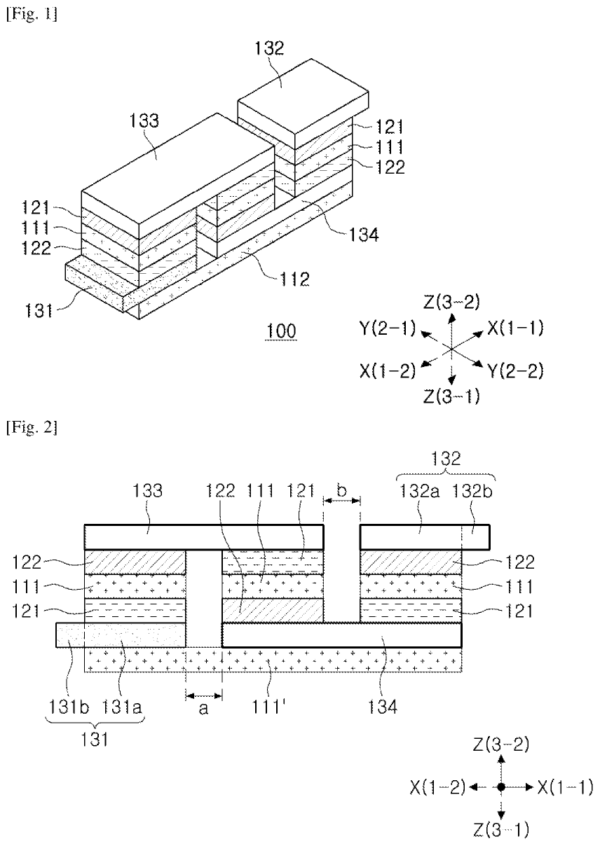

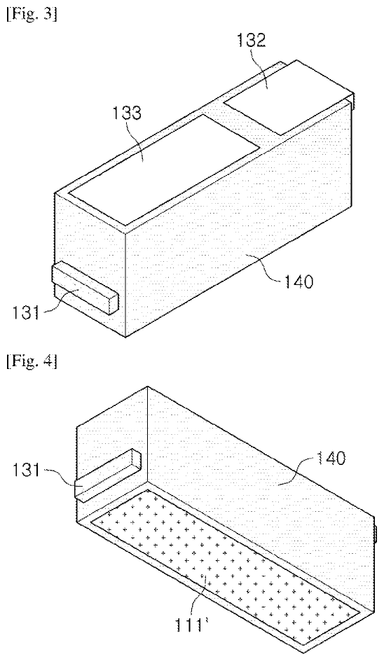

An all-solid-state battery 100 according to an embodiment is provided. FIGS. 1 to 4 are views schematically illustrating the all-solid-state battery 100 according to an embodiment of the present disclosure. Referring to FIGS. 1 to 4, the all-solid-state battery 100 according to an embodiment may include a first battery cell in which a negative electrode current collector 131 including a negative electrode lead portion 131b led out in a first direction X, a first negative electrode layer 121, a first solid electrolyte layer III and a first positive electrode layer 122 are sequentially stacked in a third direction Z, perpendicular to the first direction X; a second battery cell in which a second positive electrode layer 122, a second solid electrolyte layer III and a second negative electrode layer 121 are sequentially stacked in the third direction Z; a third battery cell in which a third negative electrode layer 121, a third solid electrolyte layer 111, a third positive electrode layer 122, and a positive electrode current collector 132 including a positive electrode lead portion 132b led out in a direction opposite to the negative lead portion 131b led out in the first direction X are sequentially stacked in the third direction Z; a first connection electrode 133 connected to the first positive electrode layer 122 and the second negative electrode layer 121; and a second connection electrode 134 connected to the second positive electrode layer 122 and the third negative electrode layer 121.

In this case, the first battery cell, the second battery cell, and the third battery cell may be disposed to be spaced apart from each other in the first direction X. In one example, referring to FIG. 6, an insulating film 145 may be disposed between the first battery cell and the second battery cell, and an insulating film 146 may be disposed between the second battery cell and the third battery cell. An all-solid-state battery of the related art uses a structure in which plate-shaped electrodes are formed to face each other. In order to implement a high-capacitance battery in the above structure, it is necessary to increase the number of stacks of the plate-shaped electrodes. However, a positive electrode layer, a negative electrode layer and a solid electrolyte layer respectively contain different materials from each other. In this case, therefore, internal stress is generated due to the difference in shrinkage behavior during the sintering process, or expansion and contraction due to the high/low temperature cycle due to charging and discharging is repeated during use of the battery after manufacturing, and thus the product is exposed to continuous mechanical stress. Thus, there is a problem in that cracks or the like occur in the product. Meanwhile, in the case of the all-solid-state battery according to an embodiment of the present disclosure, the capacitance may be increased without increasing the number of stacked layers, and the manufacturing process may be simplified by reducing the number of stacked layers. In addition, the long-term reliability may be improved by reducing the probability of poor contact between dissimilar materials through a structure with a relatively small number of stacked layers.

The first battery cell of the all-solid-state battery 100 according to an embodiment of the present disclosure may have a structure in which the negative electrode current collector 131 including the negative electrode lead portion 131b, the first negative electrode layer 121, the first solid electrolyte layer 111 and the first positive electrode layer 122 are sequentially stacked in the third direction Z perpendicular to the first direction X. In more detail, in the first battery cell, the negative electrode current collector 131, the first negative electrode layer 121, the first solid electrolyte layer 111, and the first positive electrode layer 122 may be sequentially stacked in a 3-2 direction. The negative electrode lead portion 131b may be formed as the negative electrode current collector 131 (or 131a) extends. The negative electrode lead portion 131b may be disposed to protrude in the 1-2 direction, for example.

In an example, the average length of the negative electrode current collector 131 of the all-solid-state battery according to an embodiment of the present disclosure may be greater than the average length of the first solid electrolyte layer 111. In this specification, the “length” of a member may mean a distance measured in a direction parallel to the first direction X of the member. In addition, the “average length” may mean the arithmetic average of maximum lengths of the members with respect to the three cut surfaces (X-Z plane) provided by dividing the all-solid-state battery into 4 equal parts in a direction, perpendicular to the Y-axis. The average length of the negative electrode current collector 131 may be greater than the average length of the first solid electrolyte layer 111 by at least the length of the negative electrode lead portion 131b of the negative electrode current collector 131. The negative electrode lead portion 131b may function as a negative terminal of the all-solid-state battery according to an embodiment of the present disclosure.

As the negative electrode current collector 131, a porous body such as a mesh shape may be used, and a porous metal plate including a conductive metal such as stainless steel, nickel, copper, tin, or aluminum may be used, but the negative electrode current collector 131 is not limited thereto. In addition, the negative electrode current collector 131 may be coated with an oxidation-resistant metal or alloy film to prevent oxidation.

The negative electrode layer 121 included in the all-solid-state battery 100 according to an embodiment of the present disclosure may include a component known to be usable as a negative active material. As the negative active material, a carbon-based material, silicon, silicon oxide, silicon-based alloy, silicon-carbon-based material composite, tin, tin-based alloy, tin-carbon composite, metal oxide, or combinations thereof may be used, and lithium metal and/or a lithium metal alloy may be included.

The lithium metal alloy may include lithium and a metal/metalloid capable of alloying with lithium. For example, the metal/metalloid capable of alloying with lithium may be Si, Sn, Al, Ge, Pb, Bi, Sb, a Si—Y alloy (where Y is an alkali metal, alkaline earth metal, group 13 to 16 element, transition metal, rare earth element, or combination elements thereof, and does not contain Si), a Sn—Y alloy (where Y is an alkali metal, alkaline earth metal, group 13 to 16 element, transition metal, transition metal oxide such as lithium titanium oxide (Li₄Ti₅O₁₂), rare earth element, or combination elements thereof, and does not contain Sn), MnOₓ (0<x<2), and the like. As the element Y, Mg, Ca, Sr, Ba, Ra, Sc, Y, Ti, Zr, Hf, Rf, V, Nb, Ta, Db, Cr, Mo, W, Sg, Tc, Re, Bh, Fe, Pb. Ru, Os, Hs, Rh, Ir, Pd, Pt, Cu, Ag, Au, Zn, Cd, B, Al, Ga, Sn, In, Tl, Ge, P, As, Sb, Bi, S, Se, Te, Po, or combinations thereof may be used.

In addition, the oxide of the metal/metalloid alloyable with lithium may be lithium titanium oxide, vanadium oxide, lithium vanadium oxide, SnO₂, SiOₓ(0<x<2), or the like. For example, the negative active material may include at least one element selected from the group consisting of elements from Groups 13 to 16 of the Periodic Table of Elements. For example, the negative active material may include one or more elements selected from the group consisting of Si, Ge, and Sn.

The carbon-based material may be crystalline carbon, amorphous carbon, or a mixture thereof. The crystalline carbon may be graphite such as amorphous, plate-like, flake-like, spherical or fibrous natural graphite or artificial graphite. In addition, the amorphous carbon may be soft carbon (low temperature calcined carbon) or hard carbon, mesophase pitch carbide, calcined coke, graphene, carbon black, fullerene soot, a carbon nanotube, a carbon fiber, or the like, but is not limited thereto.

The silicon may be selected from the group consisting of Si, SiOₓ (0<x<2, for example, 0.5 to 1.5), Sn, SnO₂, or silicon-containing metal alloys and mixtures thereof. The silicon-containing metal alloy may include, for example, silicon and at least one of Al, Sn, Ag, Fe, Bi, Mg, Zn, in, Ge, Pb and Ti.

The negative active material of the all-solid-state battery 100 according to an embodiment of the present disclosure may optionally include a conductive agent and a binder. The conductive agent is not particularly limited as long as it has conductivity without causing a chemical change in the all-solid-state battery of the present disclosure. For example, graphite, such as natural graphite and artificial graphite; a carbon-based substance such as carbon black, acetylene black, ketjen black, channel black, furnace black, lamp black, and thermal black; a conductive fiber such as carbon fibers and metal fibers; carbon fluoride; metal powder such as aluminum and nickel powder, conductive whisker such as zinc oxide and potassium titanate; conductive metal oxide such as titanium oxide; a conductive material such as polyphenylene derivatives.

The binder may be used to improve bonding strength between the active material and the conductive agent or the like. The binder may be polyvinylidene fluoride, polyvinyl alcohol, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene terpolymer (EPDM), sulfonated EPDM, styrene butadiene rubber, fluororubber, and various copolymers, but is not limited thereto.

The solid electrolyte layer 111 of the all-solid-state battery 100 according to an embodiment of the present disclosure may be at least one selected from the group consisting of Garnet-type, Nasicon-type, LISICON-type, perovskite-type and LiPON-type.

The Garnet-type solid electrolyte may indicate lithium-lanthanum zirconium oxide (LLZO) represented by LiₐLa_{b}Zr_{c}O₁₂, such as Li₇La₃Zr₂O₁₂. The Nasicon-based solid electrolyte may indicate lithium-aluminum-titanium-phosphate (LATP) of L₁₊ₓAlₓTi₂₋ₓ(PO₄)₃ (0<x<1) in which Ti is introduced into Li₁₊ₓAlₓM₂₋ₓ(PO₄)₃(LAMP) (0<x<2, M=Zr, Ti, Ge)-based compound, and indicate lithium-aluminum-germanium-phosphate (LAGP) represented by Li₁₊₁+AlₓGe₂₋ₓ(PO₄)₃ (0<x<1), such as L_{1.3}Al_{0.3}Ti_{1.7}(PO₄)₃, in which an excess amount of lithium is introduced, and/or lithium-zirconium-phosphate (LZP) of LiZr₂(PO₄)₃.

In addition, the LISICON-based solid electrolyte may indicate solid solution oxide represented by xLi₃AO₄-(1−x)Li₄BO₄ (A: P, As, V or the like, B: Si, Ge, Ti or the like) and including Li₄Zn(GeO₄)₄, Li₁₀GeP₂O₁₂(LGPO), Li_{3.5}Si_{0.5}P_{0.5}O₄, Li_{10.42}Si(Ge)_{1.5}P_{1.5}Cl_{0.08}O_{11.92}, or the like, and solid solution sulfide including Li₂S—P₂S₅, Li₂S—SiS₂, Li₂S—SiS₂—P₂S₅. Li₂S—GeS₂, or the like, represented by Li₄₋ₓM_{1-y}M′_{y}′S₄ (M=Si, Ge and M′=P, Al, Zn, Ga).

The perovskite-based solid electrolyte may refer to lithium-lanthanum-titanate-oxide (lithium lanthanum titanate, LLTO) represented by Li₃ₓLa_{2/3-x□1/3-2x}, TiO₃ (0<x<0.16, □ vacancy), such as Li_{1/8}La_{5/8}TiO, or the like, and the LiPON-based solid electrolyte may refer to a nitride such as lithium phosphorous-oxynitride of Li_{2.8}PO_{3.3}N_{0.46}, or the like.

The positive active material of the first positive electrode layer 122 may be, for example, a compound represented by the following formula: LiₐA_{1-b}M_{b}D₂ (where 0.90≤a≤1.8, 0≤b≤0.5); LiₐE_{1-b}M_{b}O_{2-c}D_{c} (where 0.90≤a≤1.8, 0≤b≤0.5, 0≤c≤0.05); LiE_{2-b}M_{b}O_{4-c}D_{c} (where 0≤b≤0.5, 0≤c≤0.05); LiaNi_{1-b-c}Co_{b}M_{c}D_{α} (where 0.90≤a≤1.8, 0≤b≤0.5, 0≤c≤0.05, 0≤α≤2); LiₐNi_{1-b-c}Co_{b}M_{c}O_{2-α}X_{α} (where 0.90≤a≤1.8, 0≤b≤0.5, 0≤c≤0.05, 0<α<2); LiₐNi_{1-b-c}Co_{b}M_{c}O_{2-α}X₂ (where 0.90≤a≤1.8, 0≤b≤0.5, 0≤c≤0.05, 0<α<2); LiₐNi_{1-b-c}Mn_{b}M_{c}D_{α} (where 0.90≤a≤1.8, 0≤b≤0.5, 0≤c≤0.05, 0<α≤2); LiₐNi_{1-b-c}Mn_{b}M_{c}O_{2-α}X_{α} (where 0.90≤a≤1.8, 0≤b≤0.5, 0≤c≤0.05, 0<α<2); LiₐNi_{1-b-c}Mn_{b}M_{c}O_{2-α}X₂ (where 0.90≤a≤1.8, 0≤b≤0.5, 0≤c≤0.05, 0<α<2); LiₐNi_{b}E_{c}G_{d}O₂ (where 0.90≤a≤1.8, 0≤b≤0.9, 0≤c≤0.5, 0.001≤d≤0.1); LiₐNi_{b}Co_{c}Mn_{d}GₑO₂ (where 0.90≤a≤1.8, 0≤b≤0.9, 0≤c≤0.5, 0≤d≤0.5, 0.001≤e≤0.1); LiₐNiG_{b}O₂ (where 0.90≤a≤1.8, 0.001≤b≤0.1); LiₐCoG_{b}O₂ (where 0.90≤a≤1.8, 0.001≤b≤0.1); LiₐMnG_{b}O₂ (where 0.90≤a≤1.8, 0.001≤b≤0.1); LiₐMn₂G_{b}O₄ (where 0.90≤a≤1.8.0.001≤b≤0.1); QO₂; QS₂; LiQS₂; V₂O₅; LiV₂O₂; LiRO₂; LiNiVO₄; Li_{(3-f)}J₂(PO₄)₃ (0≤f≤2); Li_{(3-f)}Fe₂(PO₄)₃ (where 0≤f≤2); and LiFePO₄, In the above formula, A is Ni, Co, or Mn; M is Al, Ni, Co, Mn, Cr, Fe, Mg, Sr, V, or a rare-earth element; D is O, F, S, or P; E is Co or Mn; X is F, S, or P; G is Al, Cr, Mn, Fe, Mg, La, Ce, Sr, or V; Q is Ti, Mo or Mn; R is Cr, V, Fe, Sc, or Y; J is V, Cr, Mn, Co, Ni, or Cu.

The positive active material may also be LiCoO₂, LiMnₓO₂ₓ (where x=1 or 2), LiNi₁₋ₓ, MnₓO₂ₓ (where 0<x<1), LiNi_{1-x-y}CoₓMn_{y}O₂ (where 0≤x≤0.5, 0≤y≤0.5), LiFePO₄, TiS₂, FeS₂, TiS₃, or FeS₃, but is not limited thereto.

The positive active material of the all-solid-state battery 100 according to an embodiment of the present disclosure may optionally include a conductive material and a binder. The conductive agent is not particularly limited as long as it has conductivity without causing a chemical change in the all-solid-state battery 100 according to an embodiment. For example, graphite, such as natural graphite and artificial graphite; a carbon-based substance such as carbon black, acetylene black, ketjen black, channel black, furnace black, lamp black, and thermal black; a conductive fiber such as carbon fibers and metal fibers; carbon fluoride; metal powder such as aluminum and nickel powder, conductive whisker such as zinc oxide and potassium titanate; conductive metal oxide such as titanium oxide; a conductive material such as polyphenylene derivatives.

The binder may be used to improve bonding strength between the active material and the conductive agent or the like. The binder may be polyvinylidene fluoride, polyvinyl alcohol, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene terpolymer (EPDM), sulfonated EPDM, styrene butadiene rubber, fluororubber, and various copolymers, but is not limited thereto.

In the second battery cell of the all-solid-state battery 100 according to an embodiment of the present disclosure, the second positive electrode layer 122, the second solid electrolyte layer 111, and the second negative electrode layer 121 may be sequentially stacked in the third direction Z. The second positive electrode layer 122, the second solid electrolyte layer 111, and the second negative electrode layer 121 may be sequentially stacked, for example, in the 3-2 direction. Descriptions of the positive electrode layer, the solid electrolyte layer, and the negative electrode layer are the same as those of the first battery cell, and thus will be omitted.

In the third battery cell of the all-solid-state battery 100 according to an embodiment of the present disclosure, the third negative electrode layer 121, the third solid electrolyte layer 111, the third positive electrode layer 122, and the positive electrode current collector 132 may be sequentially stacked in the third direction Z. The third negative electrode layer 121, the third solid electrolyte layer 111, the third positive electrode layer 122, and the positive electrode current collector 132 may be sequentially stacked in the 3-2 direction Z. The positive electrode lead portion 132b may be disposed to protrude in the 1-1 direction, for example. Descriptions of the negative electrode layer, the solid electrolyte layer, and the positive electrode layer are the same as those of the first battery cell, and thus will be omitted.

In an example, the average length of the positive electrode current collector 132 of the all-solid-state battery 100 according to an embodiment of the present disclosure may be greater than the average length of the third solid electrolyte layer 111. The average length of the positive electrode current collector 132 may be greater than the average length of the third solid electrolyte layer III by at least the length of the positive electrode lead portion 132b of the positive electrode current collector 132. The positive electrode lead portion 132b may function as a positive terminal of the all-solid-state battery according to an embodiment of the present disclosure.

The positive electrode current collector 132 may include the same configuration as the negative electrode current collector 131 described above. For the positive electrode current collector 132, a porous body such as a mesh shape may be used, and a porous metal plate including a conductive metal such as stainless steel, nickel, copper, tin, or aluminum may be used, but the configuration is not limited thereto. In addition, the positive electrode current collector 132 may be coated with an oxidation-resistant metal or alloy film to prevent oxidation.

The all-solid-state battery 100 according to an embodiment may include the first connection electrode 133 connected to the first positive electrode layer 122 and the second negative electrode layer 121, and the second connection electrode 134 connected to the second positive electrode layer 122 and the third negative electrode layer 121.

The first connection electrode 133 may be disposed on one surfaces of the first positive electrode layer 122 and the second negative electrode layer 121 in the third direction Z. In detail, the first connection electrode 133 may be disposed on the first positive electrode layer 122 and the second negative electrode layer 121 in the 3-2 direction. The first connection electrode 133 may be disposed to cover at least portions of surfaces of the first positive electrode layer 122 and the second negative electrode layer 121 in the 3-2 direction. In this specification, that the first member is disposed to “cover” the second member may indicate that the first member is disposed so that a portion of the second member covered by the first member is not exposed externally, and that the second member is hidden by the first member so that the second member is not visible in one direction perpendicular to the stacking direction of the two members.

The first connection electrode 133 may function to connect the first battery cell and the second battery cell. The structure such as a connection between the first positive electrode layer 122 of the first battery cell and the second negative electrode layer 121 of the second battery cell may be provided by the first connection electrode 133. Therefore, the first battery cell and the second battery cell may have a series-connected structure, and the capacitance may be effectively increased without increasing the number of stacked layers. In this specification, “series” may mean a state in which terminals of different polarities are connected, and may mean a state in which the same current flows. In addition, in this specification, “parallel” may mean a state in which terminals of the same polarity are connected, and may mean that they are not connected to each other in series.

The second connection electrode 134 may be disposed on one surfaces of the second positive electrode layer 122 and the third negative electrode layer 121 in the third direction Z. In detail, the second connection electrode 134 may be disposed on the second positive electrode layer 122 and the third negative electrode layer 121 in the 3-1 direction. The second connection electrode 134 may be disposed to cover at least portions of the surfaces of the second positive electrode layer 122 and the third negative electrode layer 121 in the 3-1 direction. The second connection electrode 134 may function to connect the second battery cell and the third battery cell. The structure such as a connection between the second positive electrode layer 122 of the second battery cell and the third negative electrode layer 121 of the third battery cell may be provided by the second connection electrode 134. Therefore, the second battery cell and the third battery cell may have a series-connected structure, and capacitance may be effectively increased without increasing the number of stacked layers.

A method of forming the first connection electrode 133 and the second connection electrode 134 is not particularly limited, and may be performed using a conductive paste including at least one conductive metal among, for example, silver (Ag), palladium (Pd), gold (Au), platinum (Pt), nickel (Ni), copper (Cu), tin (Sn), tungsten (W), titanium (Ti), and alloys thereof. Alternatively, the first connection electrode 133 and the second connection electrode 134 may be formed using a metal plate including the conductive metal, but the formation method is not limited thereto.

The all-solid-state battery 100 according to an embodiment of the present disclosure may further include a fourth solid electrolyte layer 111′ as a connection solid electrolyte layer connected to the negative electrode current collector 131 and the second connection electrode 134. The fourth solid electrolyte layer 111′ may serve as a substrate supporting the first battery cell, the second battery cell, and the third battery cell of the all-solid-state battery 100 according to an embodiment of the present disclosure.

In an example, the fourth solid electrolyte layer 111′ of the all-solid-state battery 100 may be disposed to cover at least portions of one surfaces of the negative electrode current collector 131 and the second connection electrode 134 in the third direction Z.

In an example of the present disclosure, the all-solid-state battery 100 according to an embodiment may further include a molding portion 140 disposed to surround the first battery cell, the second battery cell, and the third battery cell. The molding portion 140 may be disposed on the first battery cell, the second battery cell and the third battery cell in the first and second directions.

In an embodiment of the present disclosure, the first connection electrode 133 and the positive electrode current collector 131 of the all-solid-state battery 100 may be disposed to be exposed to one surface of the molding portion 140 in the third direction. In detail, the first connection electrode 133 and the positive electrode current collector 131 may be led out to the molding portion 140 in the 3-2 direction.

In another embodiment, the negative electrode current collector 131 of the all-solid-state battery 100 may be led out to one surface of the molding portion 140 in the first direction X, and the positive electrode current collector 132 may be led out to the other surface of the molding portion 140 in the first direction X. In detail, the negative electrode current collector 131 may be led out to the molding portion 140 in the 1-2 direction, and the positive electrode current collector 132 may be led out to the molding portion 140 in the 1-1 direction. A region of the negative electrode current collector 131 led out to the molding portion 140 in the 1-2 direction may be the negative electrode lead portion 131b, and a region of the positive electrode current collector 132 led out to the molding portion 140 in the 1-1 direction may be the positive electrode lead portion 132b. The negative electrode lead portion 131b and the positive electrode lead portion 132b may function as a negative terminal and a positive terminal, respectively.

The molding portion 140 may include a ceramic material, for example, alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), mixtures thereof, oxides and/or nitrides of these materials, or any other suitable ceramic materials, but the material is not limited thereto. In addition, the molding portion 140 may optionally include the above-described solid electrolyte, and may include one or more solid electrolytes, but the configuration is not limited thereto. The molding portion 140 may be formed by applying a slurry including a ceramic material to the surfaces of the battery cells. However, the present disclosure is not limited thereto. The molding portion 140 may basically serve to prevent damage to the electrode assembly due to physical or chemical stress.

In another example, the molding portion 140 of the all-solid-state battery according to an embodiment of the present disclosure may include an insulating resin. The insulating resin may be, for example, a thermosetting resin, and the thermosetting resin may indicate a resin that may be cured through an appropriate heat application or aging process. Detailed examples of the thermosetting resin may include phenol resin, urea resin, diallyl phthalate resin, melanin resin, guanamine resin, unsaturated polyester resin, polyurethane resin, epoxy resin, aminoalkyd resin, melamine-urea cocondensation resin, silicon resin, polysiloxane resin, and the like, but are not limited thereto. When using a thermosetting resin, a crosslinking agent, a curing agent such as a polymerization initiator, a polymerization accelerator, a solvent, a viscosity modifier, or the like may be further added and used as needed. The molding portion 140 may be formed by transfer molding a resin such as epoxy molding compound (EMC) to surround the plurality of battery cells, but the formation method is not limited thereto.

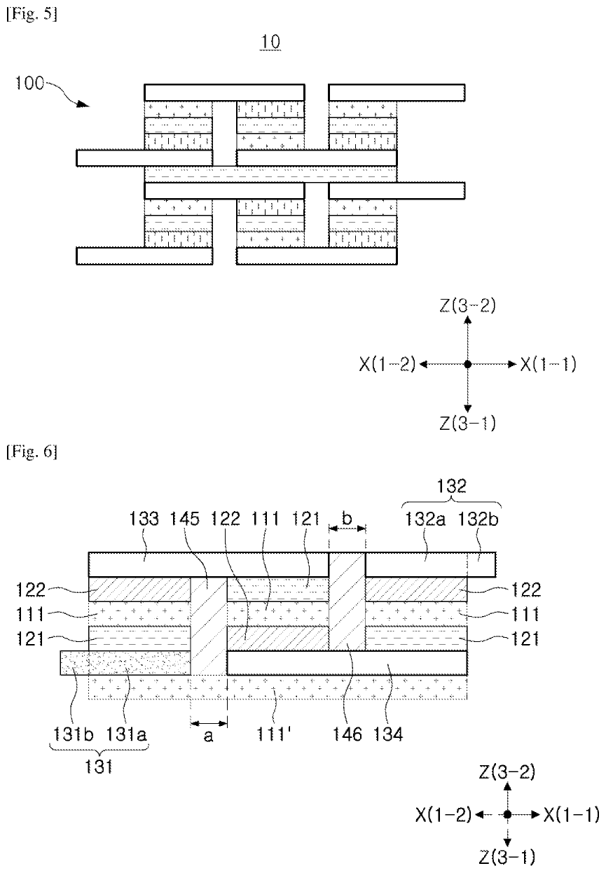

FIG. 5 is a cross-sectional view illustrating an example of a form of a battery cell according to another embodiment of the present disclosure. With reference to the all-solid-state battery 100 shown in FIGS. 1-4, an all-solid-state battery 10 shown in FIG. 5 additionally includes another unit stacking on the all-solid-state battery 100 shown in FIGS. 1-4. That is, one or more units, similar to the all-solid-state battery 100 shown in FIGS. 1-4, may be stacked on each other to increase capacitance of the all-solid-state battery 10. Other descriptions may refer to those described with reference to FIGS. 1-4 and thus will be omitted.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed to have a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

1. An all-solid-state battery comprising:
a first battery cell in which a negative electrode current collector including a negative electrode lead portion led out in a first direction, a first negative electrode layer, a first solid electrolyte layer and a first positive electrode layer are sequentially stacked in a third direction, different from the first direction; a second battery cell in which a second positive electrode layer, a second solid electrolyte layer and a second negative electrode layer are sequentially stacked in the third direction; a third battery cell in which a third negative electrode layer, a third solid electrolyte layer, a third positive electrode layer, and a positive electrode current collector including a positive electrode lead portion led out in a direction opposite to the negative lead portion led out in the first direction are sequentially stacked in the third direction;
a first connection electrode connected to the first positive electrode layer and the second negative electrode layer; and
a second connection electrode connected to the second positive electrode layer and the third negative electrode layer,
wherein the first battery cell, the second battery cell and the third battery cell are spaced apart from each other in the first direction.

2. The all-solid-state battery of claim 1, wherein an average length of the negative electrode current collector is greater than an average length of the first solid electrolyte layer.

3. The all-solid-state battery of claim 1, wherein an average length of the positive electrode current collector is greater than an average length of the third solid electrolyte layer.

4. The all-solid-state battery of claim 1, wherein the first connection electrode is disposed to cover at least portions of one surfaces of the first positive electrode layer and the second negative electrode layer in the third direction.

5. The all-solid-state battery of claim 1, wherein the second connection electrode is disposed to cover at least portions of one surfaces of the second positive electrode layer and the third negative electrode layer in the third direction.

6. The all-solid-state battery of claim 1, further comprising a connection solid electrolyte layer disposed in a direction opposite to the third direction to be connected to the negative electrode current collector and the second connection electrode.

7. The all-solid-state battery of claim 6, wherein the connection solid electrolyte layer is disposed to cover at least portions of one surfaces of the negative electrode current collector and the second connection electrode in the third direction.

8. The all-solid-state battery of claim 6, further comprising:
a fourth battery cell in which another negative electrode current collector including another negative electrode lead portion led out in the first direction, a fourth negative electrode layer, a fourth solid electrolyte layer and a fourth positive electrode layer are sequentially stacked in the third direction;
a fifth battery cell in which a fifth positive electrode layer, a fifth solid electrolyte layer and a fifth negative electrode layer are sequentially stacked in the third direction;
a sixth battery cell in which a sixth negative electrode layer, a sixth solid electrolyte layer, a sixth positive electrode layer, and another positive electrode current collector including another positive electrode lead portion led out in a direction opposite to the another negative lead portion led out in the first direction are sequentially stacked in the third direction;
a third connection electrode connected to the fourth positive electrode layer and the fifth negative electrode layer; and
a fourth connection electrode connected to the fifth positive electrode layer and the sixth negative electrode layer,
wherein the third connection electrode and the another positive electrode current collector are connected to the connection solid electrolyte layer.

9. The all-solid-state battery of claim 1, further comprising a molding portion disposed to surround the first battery cell, the second battery cell and the third battery cell.

10. The all-solid-state battery of claim 9, wherein the first connection electrode and the positive electrode current collector are disposed to be led out to one surface of the molding portion in the third direction.

11. The all-solid-state battery of claim 9, wherein the negative electrode current collector is led out to one surface of the molding portion in the first direction, and
the positive electrode current collector is led out to the other surface of the molding portion in the first direction.

12. The all-solid-state battery of claim 9, wherein the molding portion comprises an oxide or a nitride of a metal and/or non-metal compound, or a compound thereof.

13. The all-solid-state battery of claim 9, wherein the molding portion comprises an insulating resin.

14. The all-solid-state battery of claim 1, wherein the first battery cell, the second battery cell, and the third battery cell are connected in series.

15. The all-solid-state battery of claim 1, further comprising:
a first insulating film disposed between the first battery cell and the second battery cell, and
a second insulating film disposed between the second battery cell and the third battery cell.
